(19) United States
(12) Patent Application Publication
(10) Pub. No.: US 2012/0327435 A1
(43) Pub. Date: Dec. 27, 2012

(54) IMAGE FORMING APPARATUS

(76) Inventor: Hiroshi ISHII, Tokyo (JP)

(21) Appl. No.: 13/527,244

(22) Filed: Jun. 19, 2012

(30) Foreign Application Priority Data
Jun. 21, 2011 (JP) 2011-136894

(51) Int. Cl. H04N 1/60

(52) U.S. Cl. 358/1.9

(57) ABSTRACT

Disclosed is an image forming apparatus including: a specific color designation receiving unit to receive a designation of a specific color; an image forming unit to form an image of a patch for measuring the specific color designated via the specific color designation receiving unit; a measurement unit to measure a color in the image of the patch for measuring the specific color; and a control unit which is configured to control the specific color designation receiving unit, the image forming unit and the measurement unit, wherein the control unit judges whether a color shift between the designated specific color and the color in the image of the patch for measuring the specific color is within an acceptable range.

### BACKGROUND OF THE INVENTION

1. Field of the Invention

The present invention relates to an image forming apparatus for detecting the color shift of the specific color.

2. Description of Related Art

Conventionally, when the print is carried out by using a color printer, the image which is slightly different in hue from the image required by a user is occasionally output. As the reason for causing the slight hue shift, the differences in the output conditions, such as the individual difference among color image output apparatuses, the environment change, the change over time and the like, are exemplified. In case that the color which is strictly specified is required, there is some possibility that the paper on which the hue shift (color shift) is caused is treated as the paper on which printing failure is caused. Therefore, in order to eliminate the color difference which is caused when the hard copy is carried out (an image is output to paper) and the difference in color density, many technologies for previously calibrating the color reproducibility of printers are proposed.

For example, the method for calibrating the color reproducibility for the color having the highest frequency in use among the colors used in an output image (See Japanese Patent Application Publication No. 2002-118763), the method for adjusting and converting the colors of an image which is input by using RGB signals at the hard copy to output the image (See Japanese Patent Application Publication No. 2006-30998), the method for precisely printing gray having the low density (See Japanese Patent Application Publication No. 2005-288802) and the like are proposed.

A corporate color which is used in a corporate logo, a design mark or the like, is strictly specified as a component element for identifying the corporation and the design thereof. Therefore, even though the corporate color is a peculiar color, it is desired that the corporate color is output so as to become the color which is strictly specified. However, in the methods which are disclosed in the above Japanese Patent Application Publications, because the color reproducibility is calibrated on the basis of the color having the highest frequency in use or the like, it is not possible to strictly reproduce the specific color which is specified by a user.

As a method for precisely outputting a corporate color, there is a method in which a predetermined figure included in the corporate logo and the design mark is detected from the read image data and the color of the predetermined figure is printed by using the color which is previously stored (See Japanese Patent Application Publication No. 2008-148007). In this method, the image is output by converting the color of the specific part in the image data into the color which is previously stored, however, the color reproducibility is not calibrated.

### SUMMARY

To achieve at least one of the abovementioned objects, an image forming apparatus reflecting one aspect of the present invention comprises:

a specific color designation receiving unit to receive a designation of a specific color;

an image forming unit to form an image of a patch for measuring the specific color designated via the specific color designation receiving unit;

a measurement unit to measure a color in the image of the patch for measuring the specific color; and

a control unit which is configured to control the specific color designation receiving unit, the image forming unit and the measurement unit,

wherein the control unit judges whether a color shift between the designated specific color and the color in the image of the patch for measuring the specific color is within an acceptable range.

Preferably, the image forming unit forms a plurality of sample images on a recording medium, colors of the sample images are different from each other based on a reference color of the designated specific color; and

the acceptable range which is set in accordance with the plurality of sample images formed on the recording medium, is received by the specific color designation receiving unit.

Preferably, the specific color designation receiving unit receives a provisional designation of the specific color, for provisionally designating an optional color as the specific color, and receives a selection of the specific color, for selecting the provisionally-designated color as the specific color,

the control unit controls the image forming unit to calibrate a color reproducibility of the image forming unit so that the color reproducibility of the image forming unit becomes a predetermined color reproducibility,

the control unit instructs the image forming unit of which the color reproducibility is calibrated, to form an image of the provisionally-designated color which is provisionally designated as the specific color, on a recording medium, and

when the provisionally-designated color of which the image is formed on the recording medium, is selected as the specific color, the control unit determines the provisionally-designated color as the specific color.

Preferably, when the provisionally-designated color of which the image is formed on the recording medium, is not selected as the specific color, the control unit controls the image forming unit to calibrate the color reproducibility of the image forming unit.

Preferably, the image forming unit forms the image of the patch for measuring the specific color, immediately before the image forming unit prints an image data including the designated specific color.

Preferably, the image forming unit forms the image of the patch for measuring the specific color, in response to an instruction from a user via the specific color designation receiving unit.

Preferably, when the image forming unit successively prints the image data including the designated specific color, the image forming unit does not form the image of the patch for measuring the specific color until the number of times that the image forming unit prints the image data including the designated specific color exceeds a predetermined number.

Preferably, when the control unit judges that the color shift between the determined specific color and the color in the image of the patch is out of the acceptable range, the control unit controls the image forming unit to calibrate a color reproducibility of the image forming unit.

Preferably, when the control unit judges that the color shift between the determined specific color and the color in the image of the patch is out of the acceptable range, the control unit instructs the image forming unit to stop forming an image and warns a user.

Preferably, the image of the patch for measuring the specific color is formed on one of a recording medium and an image carrier.

Preferably, the measurement unit comprises a sensor to measure a density of the color in the image of the patch.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is an explanatory view showing an image forming apparatus according to the embodiment and an adjustment color sample;

FIG. 2 is a block diagram showing the schematic configuration of the image forming apparatus according to the embodiment;

FIG. 3 is a flowchart showing the setting relating to the color shift detection according to the embodiment;

FIG. 4 is a flowchart showing the operation for the setting of the specific color;

FIG. 5 is an explanatory view showing an example of the setting window for the specific color;

FIG. 6 is a flowchart showing the setting relating to the color shift detection for the specific color and the operation to be carried out after the color shift detection;

FIG. 7 is an explanatory view showing an example of the window for determining the threshold value;

FIG. 8 is an explanatory view showing the threshold value determination sample for determining the threshold value;

FIG. 9 is an explanatory view showing an example of the setting window relating to the color shift detection for the specific color and the operation to be carried out after the color shift detection; and

FIG. 10 is a flowchart showing the setting relating to the calibration of the color reproducibility for the specific color according to the embodiment.

### DETAILED DESCRIPTION OF PREFERRED EMBODIMENTS

Hereinafter, a preferred embodiment of the present invention will be explained with reference to the accompanying drawings.

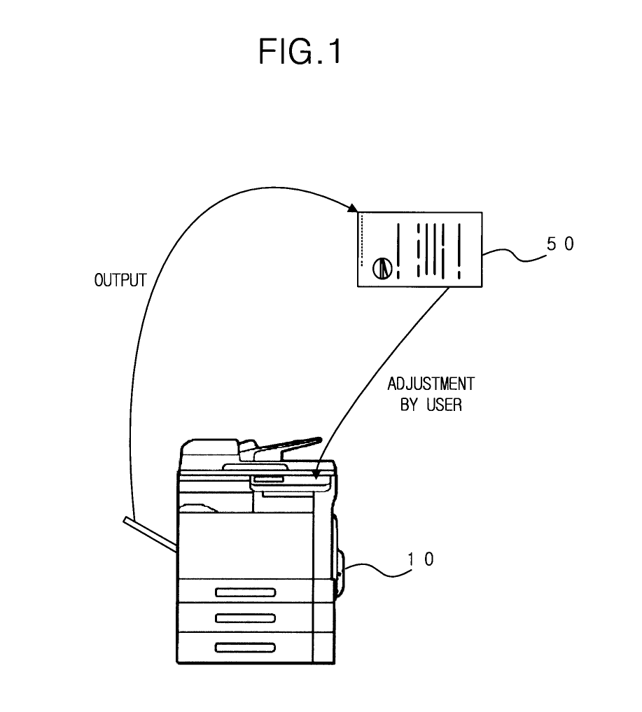

FIG. 1 shows an image forming apparatus 10 according to the embodiment and an adjustment color sample 50 which is used for the color adjustment of the image forming apparatus 10.

The image forming apparatus 10 is a so-called multi-function peripheral having a function to execute various types of jobs, such as a copy job for printing out an image on recording paper by reading an original optically, a scan job for storing an image data obtained by reading the original as a file or for transmitting it to an external terminal, a print job for printing out the image based on the print data received from a PC, on recording paper.

The image forming apparatus 10 has a function to receive the designation of the specific color from the user, to form an image of the patch for measuring the specific color, for example, in the middle of printing out an image including the specific color on a plurality of sheets, to measure the color in the patch for measuring the specific color and to warn the user of the color shift or modify the color shift when the amount of the color shift of the specific color exceeds the acceptance range.

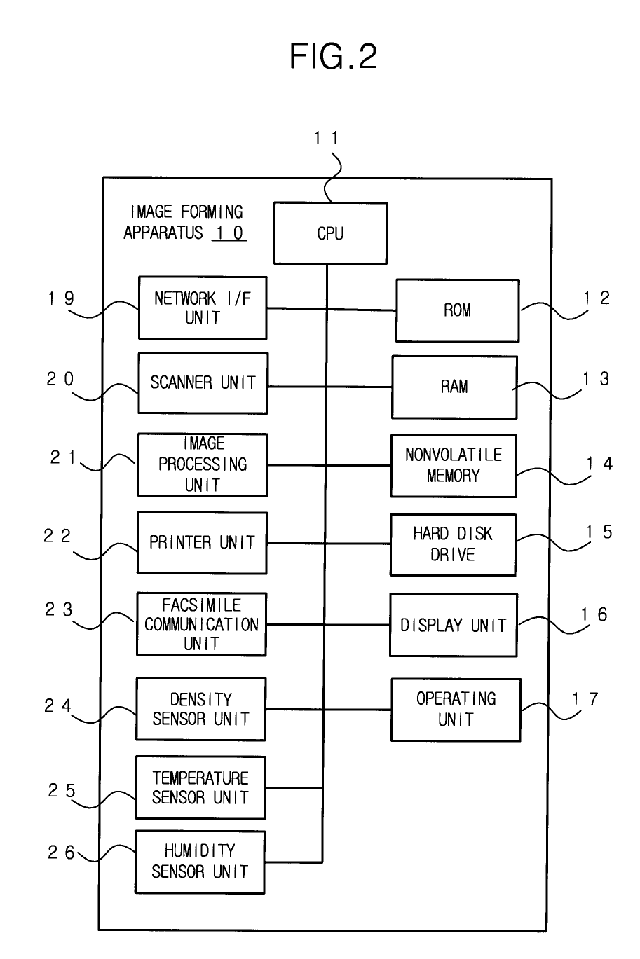

FIG. 2 shows the schematic configuration of the image forming apparatus 10. The image forming apparatus 10 comprises a CPU (Central Processing Unit) 11 for controlling the operation of the image forming apparatus 10, a ROM (Read Only Memory) 12, a RAM (Random Access Memory) 13, a nonvolatile memory 14, a hard disk drive 15, a display unit 16, an operating unit 17, a network I/F unit 19, a scanner unit 20, an image processing unit 21, a printer unit 22, a facsimile communication unit 23, a density sensor unit 24, a temperature sensor unit 25 and a humidity sensor unit 26 which are connected with the CPU 11.

By the CPU 11, a middleware, application programs and the like are executed on an OS (Operating System) program as a base. In the ROM 12, various types of programs are stored. By executing the processes by the CPU 11 in accordance with these programs, the functions of the image forming apparatus 10, such as the execution of jobs, are realized. The RAM 13 is used as a work memory for temporarily storing various data when the CPU 11 executes the programs and as an image memory for storing image data.

The nonvolatile memory 14 is a rewritable memory (flash memory) in which the contents are stored even if the multi-function peripheral 10 is turned off. In the nonvolatile memory 14, the unique information of the image forming apparatus 10, various types of setting information and the like are stored. The hard disk drive 15 is a large-capacity nonvolatile memory device, and is used in order to store the OS program, various application programs, print data, image data, job history data and the like.

The display unit 16 is configured by a liquid crystal display (LCD) or the like, and has a function to display the contents relating to various operations and settings. The operating unit 17 has a function to receive the inputs corresponding to various types of operations, such as the instruction of the jobs, the change of the settings from the user. On the basis of the inputs corresponding to the various types of operations, which are received by the operating unit 17, various functions of the image forming apparatus 10 are realized by the CPU 11. The operating unit 17 comprises a touch panel which is provided on the screen of the display unit 16. The touch panel detects a coordinate position in which the user pushes down. Further, the operating unit 17 comprises a numerical keypad, an alphabetical keypad, a start key and the like out of the screen of the display unit 16. Further, the operating unit 17 has a function as the specific color designation receiving unit to receive the designation (provisional designation) of the specific color and the like, which are described later.

The network I/F unit 19 communicates with another external device or the like which is connected via the network, such as a LAN. Further, the network I/F unit 19 has a function as the specific color designation receiving unit to receive the designation (provisional designation) of the specific color and the like by receiving the data relating to specific color which is designated (provisionally designated) by using a printer driver or an application software, from an external device such as a PC which is connected to the image forming apparatus 10 to transmit the image data.

The scanner unit 20 has a function to obtain image data by optically reading an image of an original. For example, the scanner unit 20 comprises a light source for irradiating the original with light, a line image sensor for reading the original line by line in the width direction of the original by receiving the reflected light from the original, a moving unit for sequentially moving the reading position line by line in the longitudinal direction of the original, an optical system having lenses, mirrors and the like for guiding the reflected light from the original to the line image sensor and focusing the reflected light on the line image sensor, a converting unit for converting an analog image signal outputted from the line image sensor into digital image data, and the like.

The image processing unit 21 carries out the rasterization processing for converting print data into image data, compression/decompression processing of image data and the like, in addition to the processings, such as enlargement/reduction and rotation of the image.

The printer unit 22 has a function to form an image based on image data, on recording paper. In this embodiment, the printer unit 22 is configured as the so-called laser printer for forming an image by the electrophotographic process. The laser printer comprises a conveying device for the recording paper, a photoconductive drum, a charging device, a laser unit, a developing device, a transfer and separation device, a cleaning device and a fixing device. The image may be formed by the inkjet system or another system. Further, the printer unit 22 outputs the image of the patch for measuring the specific color. The printer unit 22 is controlled by the CPU 11 so as to calibrate the color reproducibility of the printer unit 22.

The facsimile communication unit 23 controls the operation relating to the facsimile transmission and reception.

The density sensor unit 24 detects the density of each color component of the specific color in the patch for measuring the specific color, which is output by the printer unit 22. That is, the density sensor unit 24 has a function as the measurement unit to measure the color in the image of the patch for measuring the specific color. In this embodiment, the density sensor unit 24 receives the lights emitted from red, green and blue LED (Light Emitting Diode) light sources by using the photodiodes and the converts the voltages of the sensors into the LaB color system. The data relating to this conversion is corrected on the basis of the correlation with the colorimeter. As the place to which the patch for measuring the specific color is output, one sheet of paper for the printing may be used or a portion of paper, which is cut off by the cutting process for the recording paper (hereinafter, referred to as “cut portion”), may be used. Further, the photoconductive drum or the intermediate transfer belt may be used as the place to which the patch is output. The density sensor unit 24 is provided on the position corresponding to the place to which the patch is output. For example, the density sensor unit 24 is provided on the paper conveying path or in the position in which the patch output to the intermediate transfer belt or the photoconductive drum can be read.

The temperature sensor unit 25 measures the temperature in the image forming apparatus 10. The humidity sensor unit 26 measures the humidity in the image forming apparatus 10.

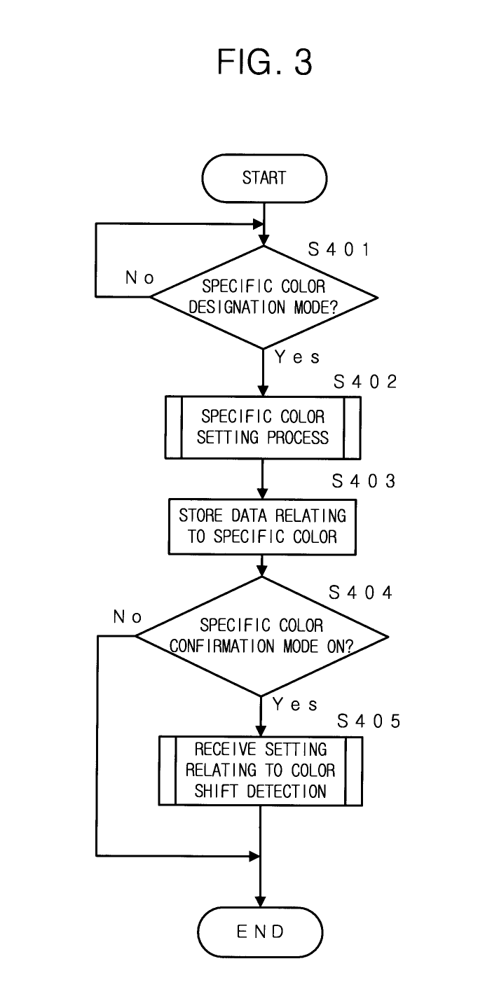

FIG. 3 shows the flowchart of the process for carrying out the setting relating to the density detection (color shift detection) of each color component of the specific color, which is carried out by the image forming apparatus 10. This process is carried out before the printing. The image forming apparatus 10 waits until the selection of the specific color designation mode is received from the user via the operating unit 17 (Step S401; No). When the operating unit 17 receives the selection of the specific color designation mode from the user (Step S401; Yes), the image forming apparatus 10 carries out the specific color setting process for receiving the designation of the specific color from the user via the operating unit 17 and for carrying out the fine adjustment of the specific color (Step S402). Then, the image forming apparatus 10 stores the data relating to the set specific color in the nonvolatile memory 14 or the like (Step S403). A plurality of specific colors may be designated.

The operating unit 17 of the image forming apparatus 10 receives the selection as to whether the color shift of the specific color set in Step S402 is detected or not (ON or OFF of the specific color confirmation mode) when the printing is carried out after the process shown in FIG. 3 is ended (Step S404). When the operating unit 17 receives the selection of the specific color confirmation mode OFF (Step S404; No), the process shown in FIG. 3 is ended. When the operating unit 17 receives the selection of the specific color confirmation mode ON (Step S404; Yes), the operating unit 17 receives the setting of various conditions for detecting the color shift of the specific color set in Step S402 from the user (Step S405), and the process shown in FIG. 3 is ended.

In the above case, the operating unit 17 receives the selection of the specific color designation mode, the designation of the specific color and the like. However, the above selection and the designation may be received by the network I/F unit 19 via a LAN from an external device, such as a PC.

In the color shift detection, firstly, the density sensor unit 24 measures each density of the color components composing the color in the patch for measuring the specific color, which is output by the printer unit 22. The position (color) in the Lab color system is specified from each density of the color components. By specifying the position in the Lab color system, it is possible to detect the color difference between the specific color designated by the user and the measured color in the Lab color system as the color shift.

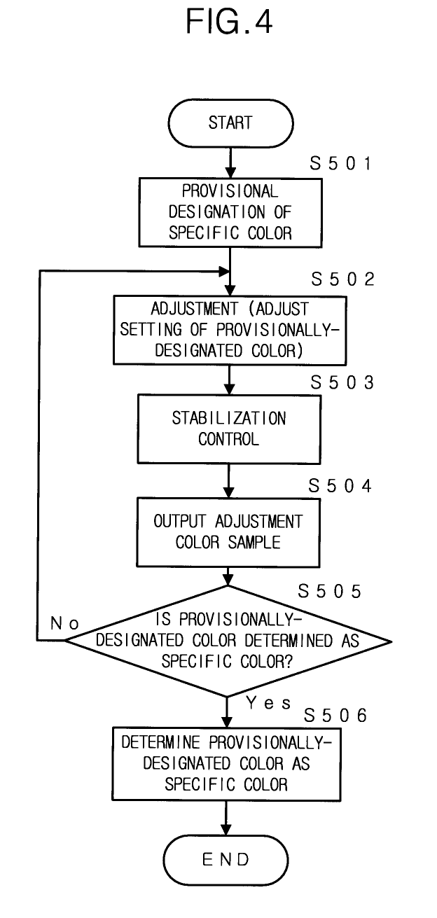

FIG. 4 shows the flowchart of the specific color setting process in Step S402 of FIG. 3.

Firstly, the operating unit 17 receives the provisional designation of the specific color from the user (Step S501). The user provisionally designates the specific color via the operating unit 17. The specific color (provisionally-designated color) is designated by displaying an image on the screen in accordance with image data obtained by reading an original by the scanner unit 20, image data which is previously stored or the like and by selecting the color from the displayed image. Then, the operating unit 17 receives the adjustment of the provisionally-designated color (Step S502). The provisional designation of the specific color and the adjustment of the provisionally-designated color can be also carried out in an external device, such as a PC connected to the image forming apparatus 10 to transmit the image data, by using a printer driver or an application program. Further, the network I/F unit 19 can receive a job relating to the above provisional designation of the specific color and the adjustment of the provisionally-designated color via the LAN. In the adjustment of the provisionally-designated color, for example, the operating unit 17 or the network I/F unit 19 receives the adjustment relating to the brightness, the contrast, the color balance and the like, from the user. Next, the CPU 11 carries out the stabilization control for calibrating the color reproducibility of the printer unit 22 in order to eliminate the color difference and the difference in the density in the hard copy (the output to the paper), which are caused by the difference in the output conditions, such as the individual difference among the apparatuses for outputting an image, the environment change (temperature change, humidity change and the like), the change over time, and the like (Step S503). In the stabilization control according to the embodiment, when the image data having the density of each color component (for example, C (cyan), M (magenta) and Y (yellow)) composing the color image is input, the CPU 11 controls the printer unit 22 to calibrate the color reproducibility of the printer unit 22 so as to reproduce (form) the image having the same density of each color component as the input image data.

Then, the image forming apparatus 10 outputs the adjustment color sample 50 in which the image of the adjusted provisionally-designated color is formed on recording paper, by the printer unit 22 after the stabilization control is carried out (Step S504). The user confirms whether the provisionally-designated color which is adjusted in Step S502 is the intended specific color, by using the adjustment color sample 50. The image forming apparatus 10 receives the selection as to whether the provisionally-designated color of the adjustment color sample 50 is determined as the specific color, via the operating unit 17 or the network I/F unit 19 (Step S505). When that the provisionally-designated color is determined as the specific color is selected (Step S505; Yes), the CPU 11 determines the current provisionally-designated color as the specific color designated by the user (Step S506) and ends the process.

When that the provisionally-designated color of the adjustment color sample 50 is determined as the specific color is not selected (Step S505; No), the process returns to Step S502. The CPU 11 continues the process for adjusting the provisionally-designated color (readjustment of the provisionally-designated color). Thereby, the specific color to be detected is determined. By determining the specific color in the above method (the method in which the specific color is determined after the stabilization control is carried out), even if the color reproducibility of the printer unit 22 is changed and the color shift is caused, it is possible to recover the color reproducibility of the printer unit 22 before the specific color is determined after the stabilization control is carried out. Therefore, it is possible to eliminate the color shift of the specific color.

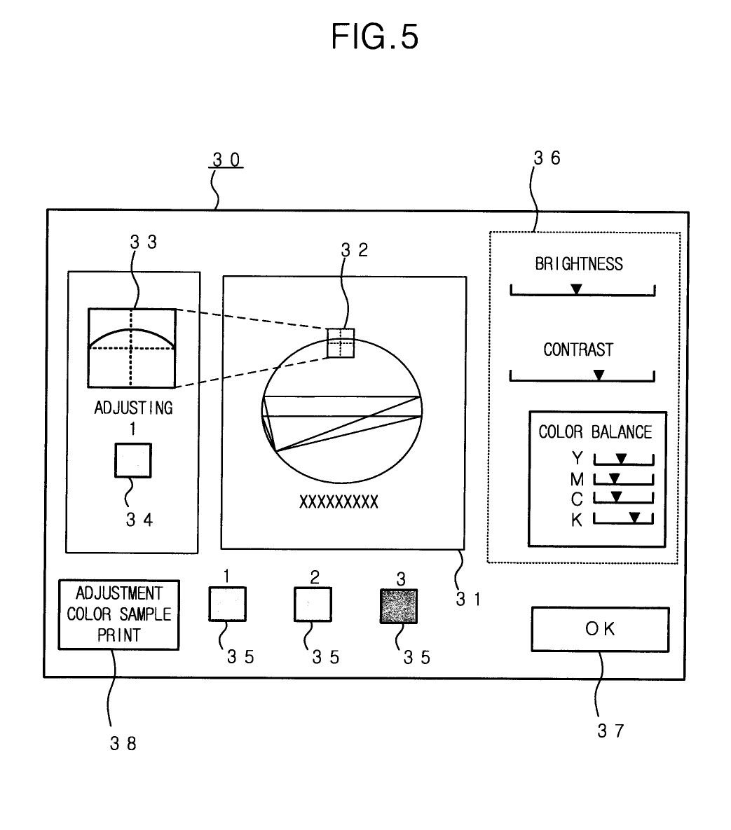

FIG. 5 shows an example of the display contents of the specific color setting window 30 which is displayed when the setting shown in FIG. 4 is carried out. In the image display area 31 provided in the center of the specific color setting window 30 shown in FIG. 5, the image to be referred when the specific color is designated is displayed. In the image display area 31, the extraction window 32 which is movable to an optional position by the user operation is displayed. In the enlargement display area 33 which is provided on the left side of the image display area 31, the image enclosed in the extraction window 32 is displayed so as to enlarge the enclosed image. In the extraction window 32, a cross-hair cursor is displayed. The color of the pixel positioned on the center point of the cross-hair cursor is designated as the provisionally-designated color 34 to be adjusted. A plurality of provisionally-designated colors can be designated. A plurality of provisionally-designated colors 35 are displayed on the lower part of the specific color setting window 30. The user selects one color among a plurality of provisionally-designated colors 35 as the provisionally-designated color 34 to be adjusted. The adjustment of the selected color is carried out.

In the right upper part of the specific color setting window 30, various types of adjustment slider bars 36 for adjusting the brightness, the contrast, the color balance and the like of the provisionally-designated color 34 to be adjusted, are displayed. The user carries out the adjustment of the provisionally-designated color 34 to be adjusted by using the adjustment slider bars 36. After all of the provisionally-designated colors 35 are adjusted by adjusting the provisionally-designated color 34 to be adjusted, the adjustment color sample 50 including the provisionally-designated colors 35 is printed by pushing the adjustment color sample print button 38 displayed on the left side of the provisionally-designated colors 35. The user determines whether the readjustment of the provisionally-designated colors 35 is carried out on the basis of the provisionally-designated colors 35 printed on the adjustment color sample 50. The OK button 37 is displayed on the right lower part of the specific color setting window 30. When the OK button 37 is pushed by the user, the provisionally-designated colors 35 are determined as the specific colors designated by the user and are stored in the nonvolatile memory 14.

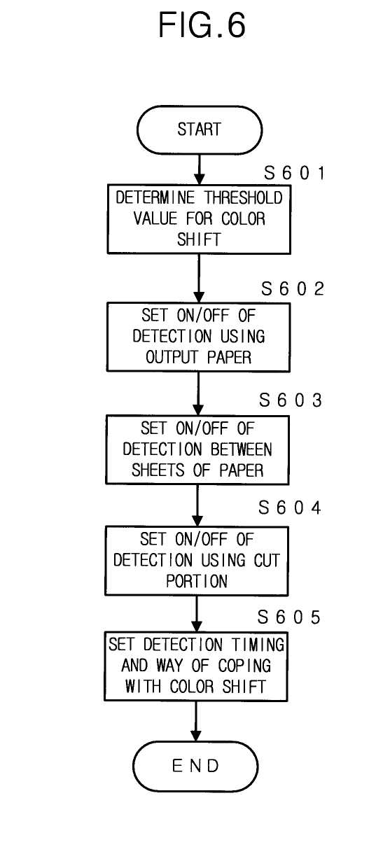

FIG. 6 shows the flowchart of the setting process relating to the color shift detection, which is shown in Step S405 of FIG. 3.

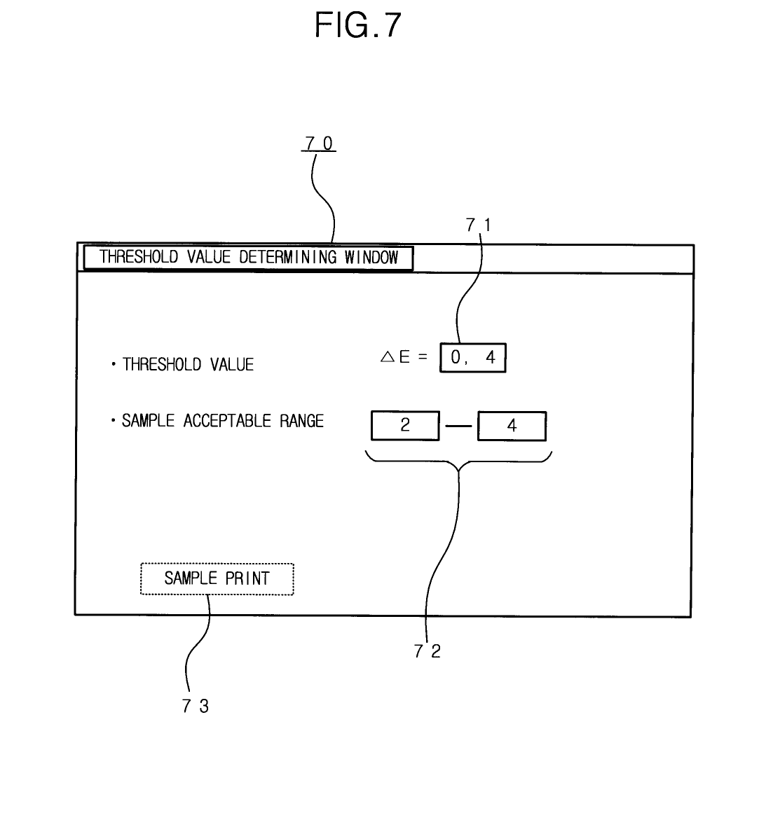

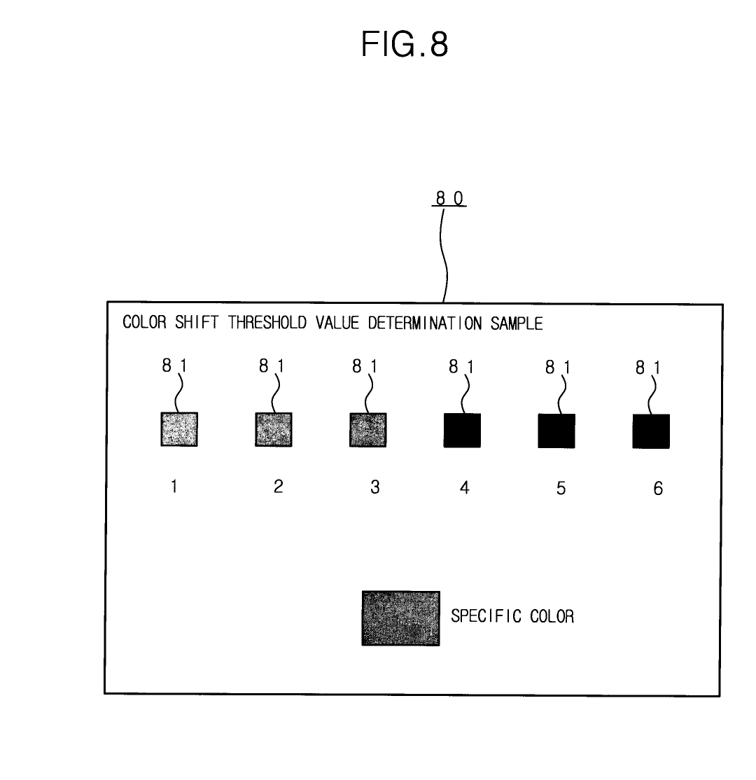

Firstly, in case that the color shift between the specific color designated by the user, which is determined in the process shown in FIG. 4 and the color in the patch for measuring the specific color, is caused, the image forming apparatus 10 receives the setting for the threshold value in which the color shift is acceptable (Step S601). FIG. 7 shows an example of the threshold value determining window 70 which is displayed when the threshold value is set in Step S601 of FIG. 6. In the middle of the threshold value determining window 70, the value 71 for setting the threshold value and the sample acceptable range 72 are displayed. In the lower part of the threshold value determining window 70, the sample print button 73 is displayed. When the image forming apparatus 10 receives the selection of the sample print button 73 from the user, the image forming apparatus 10 prints out a plurality of color shift samples 81 of which each density is gradually changed based on a reference color of the specific color designated by the user, which is determined in the process of FIG. 4, as the threshold value determination sample 80 (see FIG. 8). A plurality of color shift samples 81 of the threshold value determination sample 80 are arranged in order of the density. Further, the numbers are assigned to the color shift samples 81 on the lower side thereof. By designating the range of the numbers of the color shift samples 81 which are accepted as the specific color by the user in the sample acceptable range 72, the value 71 for setting the threshold value is determined. The value 71 is a value for setting the threshold value by using ΔE and may be directly input by the user. A plurality of color shift samples 81 may be ones of which each brightness is gradually changed.

Next, the image forming apparatus 10 receives the setting relating to the detection operation using the output paper (Step S602). Thereby, whether the patch for measuring the specific color is output to paper or not is selected. In case that the patch is output to paper, “ON” is selected. In case that the patch is not output to paper, “OFF” is selected. When “ON” is selected, the density of each color component of the specific color in the patch output to (printed on) the paper is detected by the density sensor unit 24 provided on the paper conveying path. Because the patch is actually printed on paper, it is possible to carry out the precise color shift detection. In this case, every time the patch for measuring the specific color is output, the paper for detecting the color shift is used.

The image forming apparatus 10 receives the setting relating to the detection operation carried out between sheets of paper (Step S603). Thereby, whether the patch for measuring the specific color is output to the photoconductive drum or the intermediate transfer belt or not is selected. In case that the patch is output to the drum or the belt, “ON” is selected. In case that the patch is not output to the drum or the belt, “OFF” is selected. When “ON” is selected, the density of each color component of the specific color in the patch output to the drum or the belt is detected by the density sensor unit 24. Because the patch is output to the photoconductive drum or the intermediate transfer belt, the patch is not influenced by the transfer and the fixing unlike the case that the patch is printed on the paper. Therefore, as compared with the output method in Step S602, the accuracy of the color shift detection is slightly inferior. However, in this case, because the patch is not printed on the paper, the paper for detecting the color shift is not used. The density sensor unit 24 is provided in the position in which the patch output to the intermediate transfer belt or the photoconductive drum can be read.

The image forming apparatus 10 receives the setting relating to the detection operation using the cut portion (Step S604). Thereby, in case that the cut portion of paper, which is cut off by the cutting process after the printing, is caused, whether the patch for measuring the specific color is output to (printed on) the cut portion or not is selected. In case that the patch is output to the cut portion, “ON” is selected. In case that the patch is not output to the cut portion, “OFF” is selected. When “ON” is selected, the density of each color component of the specific color in the patch output to (printed on) the cut portion is detected by the density sensor unit 24 provided on the paper conveying path. In this case, although the patch is printed on the paper, the paper for detecting the color shift is not used. Therefore, it is possible to carry out the precise color shift detection without increasing the consumption of the paper. However, in case that the cut portion is extremely small or in case that the cutting process is not carried out for the paper after the printing, this method cannot be adopted.

The image forming apparatus 10 receives the setting relating to the timing of the color shift detection and relating to the way of coping with the case in which the color shift is caused (Step S605). Then, the process is ended.

Each setting of the above Steps S601 to S605 may be carried out via the operating unit 17. Alternatively, the above settings may be carried out by an external device, such as a PC, and the network I/F unit 19 may receive the job relating to the above settings via the LAN or the like.

There are a plurality of timings for carrying out the color shift detection. The user determines whether each timing for carrying out the color shift detection is effective or not, and determines the frequency of the color shift detection. As one of a plurality of timings for carrying out the color shift detection, the color shift detection is carried out immediately before the specific color designated by the user is printed. In this embodiment, in case that the image forming apparatus 10 receives the selection of “ON” in Step S404, the color shift detection is automatically carried out. In this case, because the color shift is detected immediately before the specific color is printed, it is possible to print the specific color with high precision. However, when the specific color is successively printed, the patch for measuring the specific color is successively printed at every printing of the specific color. Therefore, in case that the specific color is successively printed, the image forming apparatus 10 can be set so as to print the patch for measuring the specific color after the number of times that the specific color is printed exceeds the predetermined number.

The predetermined number is the upper limit for the number of times of the printing in case that it is estimated that a large color shift is not caused. The predetermined number may be fixedly determined or may be set by the user. Further, the predetermined number can be dynamically changed according to the environment. In the high temperature and high humidity environment, because the color shift is easily caused, the predetermined number is preferably small.

As another timing for carrying out the color shift detection, in order to cope with the change over time (including the temperature or the like), even though the specific color designated by the user is not printed, the color shift detection is carried out after the print which is carried out the predetermined number of times since the last stabilization control until the next stabilization control (the number of times of the normal stabilization print). At this detection timing, the color shift detection for the specific color designated by the user is not required. In this embodiment, when the temperature measured by the temperature sensor unit 25 or the humidity measured by the humidity sensor unit 26 is changed, the CPU 11 judges whether the image output is influenced by the color shift and the like which are caused by the change of the temperature or the humidity. When the CPU 11 judges that the image output is influenced, the stabilization control is carried out.

When the color shift detection is carried out, the density sensor unit 24 detects the density of each color component of the color in the patch for measuring the specific color. From the detected density of each color component, the color in the patch is calculated. Further, the color difference between the color in the patch and the specific color is calculated in the color system. The CPU 11 compares the above color difference with the threshold value. As the way of coping with the detected color shift, the stabilization control or the warning is carried out when the CPU 11 judges that the detected color shift is over the threshold value. When the warning is carried out, the image output is temporarily stopped.

After the stabilization control is carried out, the printer unit 22 automatically outputs the patch for measuring the specific color. Then, the color shift detection for the output specific color is carried out. When the CPU 11 judges that the color shift which is over the threshold value is caused at the color shift detection, the image output is temporarily stopped. Further, the CPU 11 warns the user that the color reproducibility is not calibrated even though the stabilization control is carried out.

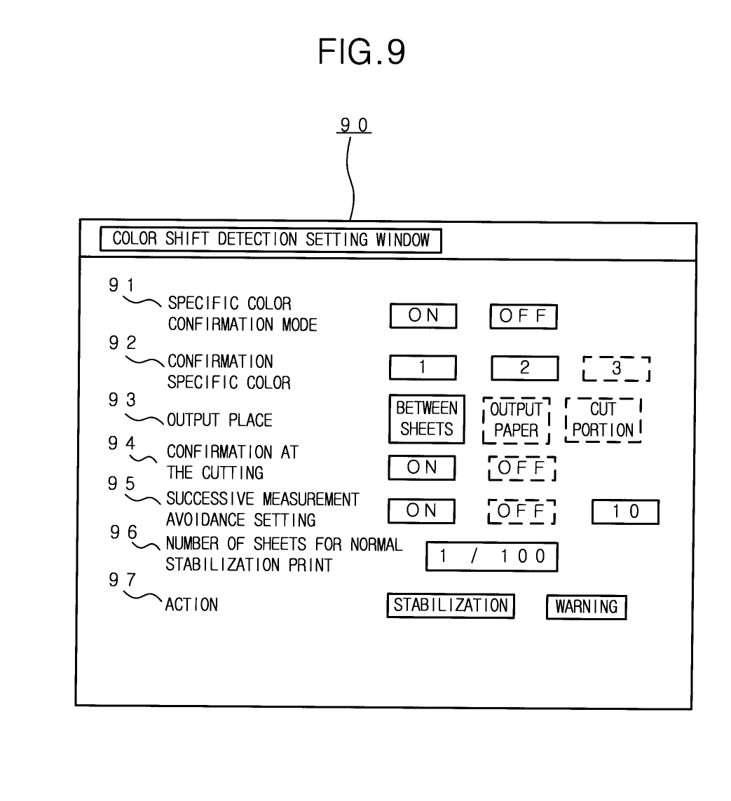

FIG. 9 shows the color shift detection setting window 90 relating to the setting process and the like in FIG. 6. In the color shift detection setting window 90, with respect to each displayed item, the conditions relating to the color shift detection can be set by switching ON/OFF and by entering the values by the user. Hereinafter, the items displayed in the color shift detection setting window 90 will be explained in order from the item provided at the top of the color shift detection setting window 90.

In the specific color confirmation mode 91, the selection relating to ON/OFF of the specific color confirmation mode in Step S404 of FIG. 3 is received from the user. The item is one for determining whether the color shift detection for the specific color designated by the user is carried out or not. When the selection is set to ON, the color shift detection is carried out. The confirmation specific color 92 is one for determining the specific color for which the color shift detection is carried out, among a plurality of specific colors designated by the user, which are stored in Step 403 of FIG. 3.

In FIG. 9, the specific color 1 and the specific color 2 are selected. In the output place 93, the place to which the patch for measuring the specific color is output is selected. The place is set in Step S602, Step S603 or Step S604 of FIG. 6. In FIG. 9, the output of the patch between the sheets of paper (the output to the photoconductive drum or the intermediate transfer belt) is selected. In the confirmation at the cutting 94, when the patch for measuring the specific color can be printed on the cut portion in Step S604 of FIG. 6, the image forming apparatus 10 receives the setting from the user as to whether the patch is preferentially printed on the cut portion. The setting as to whether the cutting is carried out or the setting relating to the size of the cut portion is carried out via another window (not shown in the drawings).

The successive measurement avoidance setting 95 is one for setting the number of times of avoiding the output of the patch in case that the image data including the specific color is successively printed. For example, when the number of times is set to 10, firstly, the patch for measuring the specific color is output immediately before the first print of the image data including the specific color. Then, in case that the image data to be printed includes the specific color, the CPU 11 judges that the print of the image data including the specific color is successive. The printer unit 22 does not print the patch for measuring the specific color until the image data including the specific color is printed 10 successive times. Because the number of times of printing the patch decreases, it is possible to suppress the consumption of the toners.

In the number of the sheets for the normal stabilization print 96, even though the image data including the specific color designated by the user is not printed, the number of times of the printing to be carried out since the last stabilization control until the next stabilization control (the number of times of the normal stabilization print) is set. Thereby, it is possible to cope with the change (including the temperature or the like) of the image forming apparatus 10 over time.

In the action 97, the image forming apparatus 10 receives the selection from the user between the stabilization control and the warning which are carried out when the CPU 11 judges that the color shift detected by the color shift detection using the patch is over the threshold value set in Step S601 of FIG. 6. The explanation of FIG. 9 is finished.

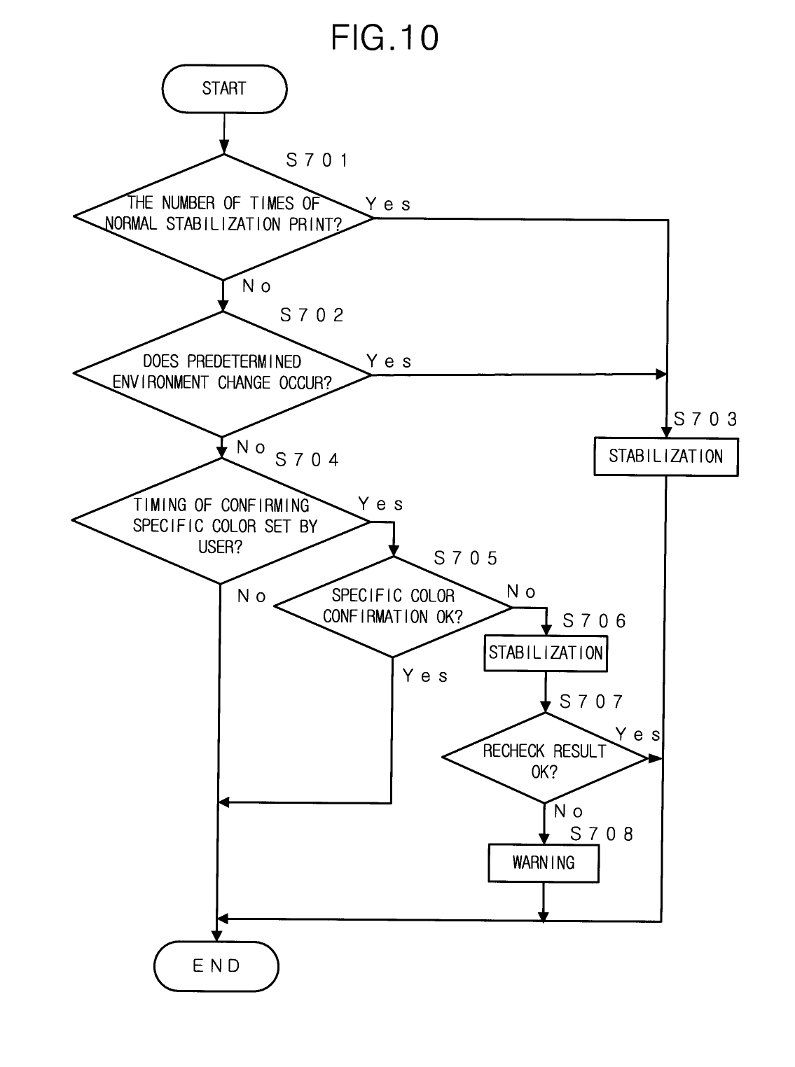

FIG. 10 shows the flowchart of the process for carrying out the stabilization control by the image forming apparatus 10 when the specific color confirmation mode is ON in Step S404 of FIG. 3, that is, when the color shift of the specific color designated by the user is detected. This process is repeatedly carried out.

Firstly, when the number of times of the printing carried out since the last stabilization control reaches the number of times of the normal stabilization print (Step S701; Yes), the image forming apparatus 10 carries out the stabilization control (Step S703). Then, the process is ended. When the number of times of the printing carried out since the last stabilization control does not reach the number of times of the normal stabilization print (Step S701; No), the process proceeds to Step S702. In case that the predetermined environment change (such as the change in the temperature or the humidity, which exceeds the predetermined level) occurs (Step S702; Yes), the image forming apparatus 10 carries out the stabilization control (Step S703). Then, the process is ended. In case that the predetermined environment change does not occur (Step S702; No), the process proceeds to Step S704.

In case that the current time is the timing for carrying out the color shift detection, which is set in Step S605 of FIG. 6 (color shift confirmation timing) (Step S704; Yes), the process proceeds to Step S705. At this time, the color shift of the specific color is detected and the CPU 11 judges whether the detected color shift of the specific color is out of the threshold value set in Step S601 of FIG. 6. In case that the current time is not the timing for carrying out the color shift detection, which is set in Step S605 of FIG. 6 (Step S704; No), the process is ended. When the CPU 11 judges that the detected color shift of the specific color is not out of the threshold value set in Step S601 of FIG. 6 (Step S705; Yes), the process is ended. When the CPU 11 judges that the detected color shift of the specific color is out of the threshold value set in Step S601 of FIG. 6 (Step S705; No), the process proceeds to Step S706. In this embodiment, the patch for measuring the specific color is output to the place which is set in Step S602, Step S603 or Step S604 of FIG. 6. The density sensor unit 24 detects the density of each color component of the color in the patch. The color difference between the color in the patch and the specific color designated by the user is calculated in the color system. The CPU 11 judges whether the calculated color difference is out of the threshold value set in Step S601 of FIG. 6.

Then, the stabilization control is carried out (Step S706). In this case, in Step 605 of FIG. 6, the image forming apparatus 10 is set so as to carry out not the warning but the stabilization control. After the stabilization control is carried out, the patch is output to the place which is set in Step S602, Step S603 or Step S604 of FIG. 6 again. After the density of the specific color is detected, the CPU 11 judges whether the detected density is out of the threshold value set in Step S601 of FIG. 6 (Step S707). When the density of the specific color, which is detected again, is not out of the threshold value set in Step S601 of FIG. 6 (Step S707; Yes), the CPU 11 judges that the stabilization control is finished with no trouble and ends the process. When the density of the specific color, which is detected again, is out of the threshold value set in Step S601 of FIG. 6 (Step S707; No), the image output is stopped. Then, the image forming apparatus 10 warns the user that the stabilization control is not finished (Step S708) and the process is ended.

The stabilization control carried out in Step S703 is not one to be carried out due to the color shift of the specific color. Therefore, after the stabilization control is carried out in Step S703, the color shift detection is not carried out again like Step S707.

As described above, in the embodiment, the specific color used as a corporate color or the like is designated. The color shift of the specific color is detected. When the color shift is caused, it is possible to suppress the paper on which the printing failure is caused due to the color shift of the specific color, by the stabilization control.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

The timing for carrying out the color shift detection is not limited to ones which are explained in the embodiment. The density can be detected at another timing. For example, even though the image data is not printed, the color shift detection may be started by the user's operation.

One of the objects of the above embodiment is to provide an image forming apparatus for detecting the color shift of the specific color designated by a user or the like.

In the above embodiment, the image forming apparatus forms the patch for measuring the designated specific color and measures the designated specific color. Thereby, when the color shift between the designated specific color and the color in the patch is caused, the color shift (color difference) is detected. It is possible to contribute to the prevention of the printing failure which is caused due to the color shift of the specific color. The number of the specific colors to be designated may be one or more. The image of the patch for measuring the specific color is formed on recording paper, the intermediate transfer belt or the photoconductive drum.

In the above embodiment, the acceptable range of the color shift between the patch and the specific color is set. As a reference for setting the acceptable range, a plurality of samples which are output to the recording paper so as to finely change the brightness, the density or the like from the specific color, are used. Then, the acceptable range is set by referring the samples. The amount of the above change in the brightness, the density or the like of the color can be optionally set.

In the above embodiment, when the specific color is determined, the user considers the specific color which is output to the recording paper after the calibration of the color reproducibility, such as the stabilization control, is carried out. By determining the specific color in the above method, even if the color shift is caused by changing the color reproducibility of the image forming unit, the color reproducibility of the image forming unit is recovered by calibrating the color reproducibility before the specific color is determined. Therefore, it is possible to eliminate the color shift of the specific color by carrying out the calibration of the color reproducibility.

In the above embodiment, until the provisionally-designated color of which the image is formed on the recording medium, is selected as the specific color, the calibration of the color reproducibility of the image forming unit is carried out. Incase that the provisionally-designated color is not selected as the specific color, such as the case that the provisionally-designated color of which the image is formed on the recording medium is shifted from the specific color, the calibration of the color reproducibility, such as the stabilization control, is carried out again. Thereby, the color shift is eliminated.

In the above embodiment, the color shift detection for the specific color is carried out immediately before the image forming unit prints the image data including the designated specific color. By examining whether the color shift is caused, it is possible to contribute to the prevention of the printing failure which is caused due to the color shift of the specific color. By detecting the color shift immediately before the specific color is printed, it is possible to precisely print the specific color.

In the above embodiment, in case that the color shift detection is carried out every time immediately before the designated specific color is printed, when the image data including the specific color is successively printed, the colors shift detection is carried out every time. Therefore, in case that the image data including the specific color is successively printed, the color shift detection is not carried out until the number of times of the above successive prints exceeds the predetermined number. It is possible to optimize and minimize the number of times of the color shift detection. The predetermined number is the upper limit for the number of times of the printing in case that it is estimated that a large color shift is not caused. The predetermined number may be fixedly determined or may be set by the user. Further, the predetermined number can be dynamically changed according to the environment. In the high temperature and high humidity environment, because the color shift is easily caused, the predetermined number is preferably small.

According to the image forming apparatus which is disclosed in the above embodiment, by detecting the color shift of the designated specific color, it is possible to contribute to the prevention of the printing failure which is caused due to the color shift of the specific color.

What is claimed is:

1. An image forming apparatus comprising:
a specific color designation receiving unit to receive a designation of a specific color;
an image forming unit to form an image of a patch for measuring the specific color designated via the specific color designation receiving unit;
a measurement unit to measure a color in the image of the patch for measuring the specific color; and
a control unit which is configured to control the specific color designation receiving unit, the image forming unit and the measurement unit,
wherein the control unit judges whether a color shift between the designated specific color and the color in the image of the patch for measuring the specific color is within an acceptable range.

2. The image forming apparatus of claim 1,
wherein the image forming unit forms a plurality of sample images on a recording medium, colors of the sample images are different from each other based on a reference color of the designated specific color; and
the acceptable range which is set in accordance with the plurality of sample images formed on the recording medium, is received by the specific color designation receiving unit.

3. The image forming apparatus of claim 1,
wherein the specific color designation receiving unit receives a provisional designation of the specific color, for provisionally designating an optional color as the specific color, and receives a selection of the specific color, for selecting the provisionally-designated color as the specific color,
the control unit controls the image forming unit to calibrate a color reproducibility of the image forming unit so that the color reproducibility of the image forming unit becomes a predetermined color reproducibility,
the control unit instructs the image forming unit of which the color reproducibility is calibrated, to form an image of the provisionally-designated color which is provisionally designated as the specific color, on a recording medium, and
when the provisionally-designated color of which the image is formed on the recording medium, is selected as the specific color, the control unit determines the provisionally-designated color as the specific color.

4. The image forming apparatus of claim 3,
wherein when the provisionally-designated color of which the image is formed on the recording medium, is not selected as the specific color, the control unit controls the image forming unit to calibrate the color reproducibility of the image forming unit.

5. The image forming apparatus of claim 1,
wherein the image forming unit forms the image of the patch for measuring the specific color, immediately before the image forming unit prints an image data including the designated specific color.

6. The image forming apparatus of claim 1,
wherein the image forming unit forms the image of the patch for measuring the specific color, in response to an instruction from a user via the specific color designation receiving unit.

7. The image forming apparatus of claim 5,
wherein when the image forming unit successively prints the image data including the designated specific color, the image forming unit does not form the image of the patch for measuring the specific color until the number of times that the image forming unit prints the image data including the designated specific color exceeds a predetermined number.

8. The image forming apparatus of claim 1,
wherein when the control unit judges that the color shift between the determined specific color and the color in the image of the patch is out of the acceptable range, the control unit controls the image forming unit to calibrate a color reproducibility of the image forming unit.

9. The image forming apparatus of claim 1,
wherein when the control unit judges that the color shift between the determined specific color and the color in the image of the patch is out of the acceptable range, the control unit instructs the image forming unit to stop forming an image and warns a user.

10. The image forming apparatus of claim 1,
wherein the image of the patch for measuring the specific color is formed on one of a recording medium and an image carrier.

11. The image forming apparatus of claim 1,
wherein the measurement unit comprises a sensor to measure a density of the color in the image of the patch.

12. An image forming apparatus for forming an image in accordance with an image data, comprising:
an input unit to receive information relating to a specific color designated by a user;
an image forming unit to form an image of a patch for measuring the designated specific color;
a measurement unit to measure a color in the image of the patch for measuring the designated specific color; and
a control unit which is configured to control the input unit, the image forming unit and the measurement unit,
wherein the control unit judges whether a color shift between the designated specific color and the color in the image of the patch is within an acceptable range.

13. The image forming apparatus of claim 12,
wherein the control unit controls the image forming unit to calibrate a color reproducibility of the image forming unit so that the color reproducibility of the image forming unit becomes a predetermined color reproducibility, and
the specific color is adjusted to an intended color by adjusting the designated specific color by a user and by calibrating a color reproducibility of the image forming unit.

14. The image forming apparatus of claim 12,
wherein the image forming unit forms the image of the patch for measuring the specific color, immediately before the image forming unit prints an image data including the designated specific color.

15. The image forming apparatus of claim 12,
wherein the image forming unit forms the image of the patch for measuring the specific color, in response to an instruction from a user via the input unit.

16. The image forming apparatus of claim 14,
wherein when the image forming unit successively prints the image data including the designated specific color, the image forming unit does not form the image of the patch for measuring the specific color until the number of times that the image forming unit prints the image data including the designated specific color exceeds a predetermined number.

17. The image forming apparatus of claim 12,
wherein when the control unit judges that the color shift between the determined specific color and the color in the image of the patch is out of the acceptable range, the control unit controls the image forming unit to calibrate a color reproducibility of the image forming unit.

18. The image forming apparatus of claim 12,
wherein when the control unit judges that the color shift between the determined specific color and the color in the image of the patch is out of the acceptable range, the control unit instructs the image forming unit to stop forming an image and warns a user.

19. The image forming apparatus of claim 12,
wherein the image of the patch for measuring the specific color is formed on one of a recording medium and an image carrier.
